(19) United States
(12) Patent Application Publication
(10) Pub. No.: US 2023/0284240 A1
(43) Pub. Date: Sep. 7, 2023

(54) HARQ-ACK IN CARRIER AGGREGATION WITH MULTIPLE SERVING CELLS

(71) Applicant: Samsung Electronics Co., Ltd., Suwon-si (KR)

(72) Inventors: Hamid SABER, San Diego, CA (US); Jung Hyun BAE, San Diego, CA (US)

(21) Appl. No.: 18/174,574

(22) Filed: Feb. 24, 2023

Related U.S. Application Data
(60) Provisional application No. 63/316,407, filed on Mar. 3, 2022.
(60) Provisional application No. 63/388,603, filed on Jul. 12, 2022.
(60) Provisional application No. 63/392,815, filed on Jul. 27, 2022.
(60) Provisional application No. 63/415,263, filed on Oct. 11, 2022.
(60) Provisional application No. 63/419,283, filed on Oct. 25, 2022.
(60) Provisional application No. 63/440,856, filed on Jan. 24, 2023.

(51) Int. Cl. H04W 72/232; H04W 72/1273; H04L 1/1867; H04L 5/00

(52) U.S. Cl. CPC H04W 72/232; H04W 72/1273; H04L 1/1893; H04L 5/001

(57) ABSTRACT

A system and a method are disclosed for HARQ-ACK in carrier aggregation with multiple serving cells. In some embodiments, the method includes: receiving, by a User Equipment (UE), a Downlink Control Information (DCI) scheduling: a first Physical Downlink Shared Channel (PDSCH) in a first Component Carrier (CC), and a second PDSCH in a second CC; calculating, by the UE, a comparison value for the DCI; and transmitting one or more Acknowledgement/Negative Acknowledgment (A/N) bits based on the comparison value, the calculating including performing a count over received PDSCHs of CCs with carrier indexes up to and including a carrier index of a reference CC.

### CROSS-REFERENCE TO RELATED APPLICATION

This application claims the priority benefit under 35 U.S.C. § 119(e) of U.S. Provisional Application No. 63/316,407, filed on Mar. 3, 2022, and of U.S. Provisional Application No. 63/388,603, filed on Jul. 12, 2022, and of U.S. Provisional Application No. 63/392,815, filed on Jul. 27, 2022, and of U.S. Provisional Application No. 63/415,263, filed on Oct. 11, 2022, and of U.S. Provisional Application No. 63/419,283, filed on Oct. 25, 2022, and of U.S. Provisional Application No. 63/440,856, filed on Jan. 24, 2023, the disclosure of each of which is incorporated by reference in its entirety as if fully set forth herein.

### TECHNICAL FIELD

The disclosure generally relates to wireless communications. More particularly, the subject matter disclosed herein relates to improvements to mobile communications systems.

### SUMMARY

In a cellular system operating according to the Fifth Generation of Mobile Telephony (5G) standard promulgated by the 3rd Generation Partnership Project (3GPP), a User Equipment (UE) may receive a Downlink (DL) Control Information (DCI) by monitoring a Physical Downlink (DL) Control Channel (PDCCH) to obtain scheduling information of a Physical DL Shared Channel (PDSCH) and a Physical Uplink (UL) Shared Channel (PUSCH).

Communication with multiple carriers is supported in the form of Carrier Aggregation (CA). In CA, a UE is able to use multiple Component Carriers (CCs) for DL and UL, allowing the UE to utilize a larger bandwidth than what would be possible using a single CC. There can be multiple modes of CA, including (i) intra-b and frequency aggregation with contiguous CCs (ii) intra-band frequency aggregation with non-contiguous CCs, and (iii) inter-band frequency aggregation with non-contiguous CCs.

The aforementioned categorization of CA modes is dependent on the collection of bands containing the CCs that are used; this collection of bands is referred to as the band combination. The UE initially connects to one cell in the CA, which is referred to as the Primary Cell (PCell). Then, the UE finds and connects to multiple other cells in the CA, referred to as Secondary Cells (SCells).

The aforementioned CA can be extended to Dual Connectivity (DC) which may provide higher per-user throughput by offloading data from a master node to a secondary node in case the master node is overloaded. Offloading data from a macro cell to a small cell is an example use case. In a typical scenario the UE is connected to the master node first and then is connected to the secondary node. EN-DC, NE-DC and NN-DC refer to the DC scenarios where the master node and secondary nodes are an evolved node B (eNB), a next generation node B (gNB), (gNB, eNB) and (gNB, gNB), respectively. Deployment scenarios where the nodes are of different radio access technologies are referred to as MR-DC. NE-DC and EN-DC are two examples of MR-DC.

In some embodiments, multiple scheduled cells are scheduled with one DCI on the scheduling cell. To reduce the control signaling overhead for scheduling downlink or uplink data channels, one DCI may schedule multiple different transport blocks (TB's) in multiple cells in a CA deployment.

One issue with the above approach is that the signaling of certain parameters ordinarily sent per PDSCH may not be clearly defined when a single DCI schedules multiple PDSCHs using cross-carrier scheduling.

To overcome these issues, systems and methods are described herein for defining unambiguous signaling methods for such parameters. The above approaches improve on previous methods because they eliminate the ambiguity that may otherwise be present.

According to an embodiment of the present disclosure, there is provided a method, including: receiving, by a User Equipment (UE), a Downlink Control Information (DCI) scheduling: a first Physical Downlink Shared Channel (PDSCH) in a first Component Carrier (CC), and a second PDSCH in a second CC; calculating, by the UE, a comparison value for the DCI; and transmitting one or more Acknowledgement/Negative Acknowledgment (A/N) bits based on the comparison value, the calculating including performing a count over received PDSCHs of CCs with carrier indexes up to and including a carrier index of a reference CC.

In some embodiments, the method further includes comparing the comparison value to a C-DAI value of the DCI.

In some embodiments, the method further includes retrieving, from the DCI, exactly one C-DAI value.

In some embodiments, the reference CC is the CC, of the first CC and the second CC, having the greater carrier index.

In some embodiments, the reference CC is the CC, of the first CC and the second CC, having the smaller carrier index.

In some embodiments, the performing of the count includes counting PDSCHs.

In some embodiments, the performing of the count includes counting PDCCHs.

In some embodiments, the method further includes: reserving, by the UE, M×N_{HARQ-ACK,max}^{CBG/TB,max} Acknowledgment/Negative Acknowledgment (A/N) bits, where M is the maximum number of PDSCHs that can be scheduled by a DCI across a plurality of serving cells; determining that the DCI schedules K≤M PDSCHs; and including the A/N bits of the K PDSCHs in a set order based on indices of the serving cells.

In some embodiments, the reserving of the A/N bits includes reserving only M A/N bits.

In some embodiments, the set order is ascending order of the indices.

In some embodiments, the set order is descending order of the indices.

In some embodiments, M is Radio Resource Control (RRC) configured to the UE by a network node (gNB).

According to an embodiment of the present disclosure, there is provided a User Equipment (UE) including: one or more processors; and a memory storing instructions which, when executed by the one or more processors, cause performance of: receiving a Downlink Control Information (DCI) scheduling: a first Physical Downlink Shared Channel (PDSCH) in a first Component Carrier (CC), and a second PDSCH in a second CC; and calculating a comparison value for the DCI, the calculating including performing a count over received PDSCHs of CCs with carrier indexes up to and including a carrier index of a reference CC.

In some embodiments, the instructions, when executed by the one or more processors, further cause performance of comparing the comparison value to a C-DAI value of the DCI.

In some embodiments, the instructions, when executed by the one or more processors, further cause performance of retrieving, from the DCI, exactly one C-DAI value.

In some embodiments, the reference CC is the CC, of the first CC and the second CC, having the greater carrier index.

In some embodiments, the reference CC is the CC, of the first CC and the second CC, having the smaller carrier index.

In some embodiments, the performing of the count includes counting PDSCHs.

In some embodiments, the performing of the count includes counting PDCCHs.

According to an embodiment of the present disclosure, there is provided a User Equipment (UE) including: means for processing; and a memory storing instructions which, when executed by the means for processing, cause performance of: receiving a Downlink Control Information (DCI) scheduling: a first Physical Downlink Shared Channel (PDSCH) in a first Component Carrier (CC), and a second PDSCH in a second CC; and calculating a comparison value for the DCI, the calculating including performing a count over received PDSCHs of CCs with carrier indexes up to and including a carrier index of a reference CC.

### BRIEF DESCRIPTION OF THE DRAWINGS

In the following section, the aspects of the subject matter disclosed herein will be described with reference to exemplary embodiments illustrated in the figures, in which:

FIG. 1 is a system diagram of a deployment, according to some embodiments;

FIG. 2 is a scheduling diagram, according to some embodiments;

FIG. 3 is a scheduling diagram, according to some embodiments;

FIG. 4A is a scheduling diagram, according to some embodiments;

FIG. 4B is a scheduling diagram, according to some embodiments;

FIG. 5A is a scheduling diagram, according to some embodiments;

FIG. 5B is a scheduling diagram, according to some embodiments;

FIG. 6A is a scheduling diagram, according to some embodiments;

FIG. 6B is a resource element diagram, according to some embodiments;

FIG. 6C is a resource element diagram, according to some embodiments;

FIG. 7A is a diagram of a portion of a wireless system, according to some embodiments;

FIG. 7B is a flow chart of a method, according to some embodiments; and

FIG. 8 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “predetermined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X-Y and the second quantity is at most X+Y. As used herein, when a second number is “within Y %” of a first number, it means that the second number is at least (1−Y/100) times the first number and the second number is at most (1+Y/100) times the first number. As used herein, the term “or” should be interpreted as “and/or”, such that, for example, “A or B” means any one of “A” or “B” or “A and B”.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

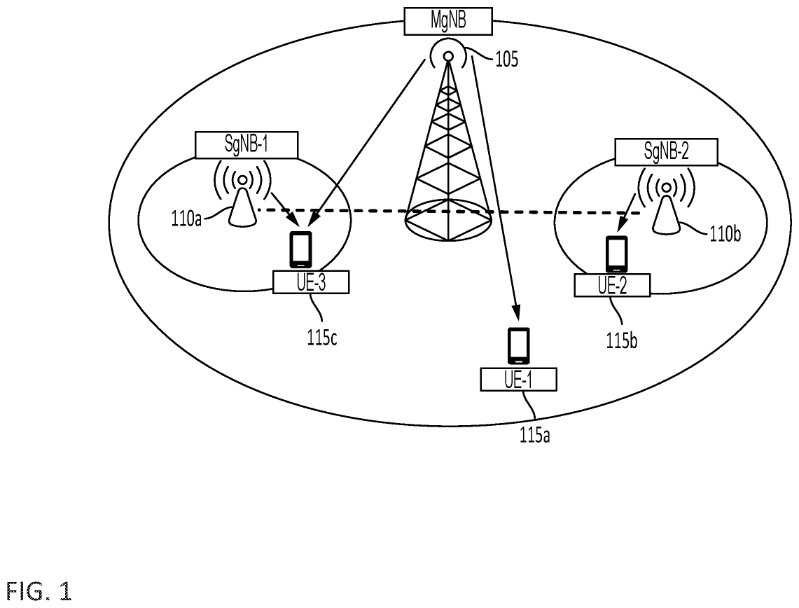

FIG. 1 shows a NN-DC deployment scenario including a master node (MgNB) 105, two secondary nodes (SgNB-1 and SgNB-2) 110a and 110b, and three UEs (UE-1, UE-2, and UE-3) 115a, 115b, 115c. In the example of FIG. 1, UE-3 is in DC mode and is simultaneously connected to two New Radio (NR) nodes, i.e., gNBs. The master node (MgNB) 105 configures a set of serving cells within the master cell group (MCG) and each of the secondary nodes (SgNB) 110a, 110b configures a set of serving cells within the secondary cell group (SCG). The primary cell of the MCG is referred to as the PCell while the secondary cells of the MCG are referred to as SCells. The primary cell of the SCG is referred to as PSCell. PCell and PSCell are also referred to as special cells (SpCell).

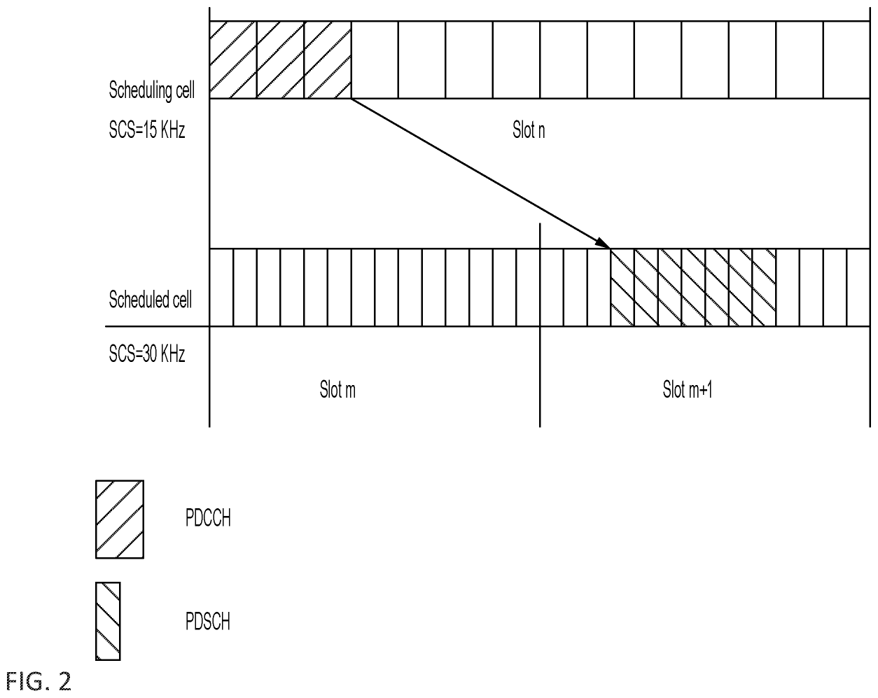

Some embodiments relate to CA deployment scenarios, and the concepts disclosed herein may be extended to each cell group in DC scenarios. In CA, a PDCCH is typically transmitted in each cell to schedule the PDSCH or PUSCH on that cell. This may not be the case, however, in case of cross carrier scheduling (CCS) where a cell, referred to as the scheduling cell, transmits a DCI for a different cell, referred to as a scheduled cell. CCS may be done between scheduling cell and scheduled cell with the same or different numerology μ₁ for scheduling cell and μ₂ for the scheduled cell. CCS with different numerologies, i.e., with μ₁≠μ₂, has a strong use case for frequency range (FR1) scheduling FR2. This is because FR1 (e.g., at frequencies below 6 GHz) may have better coverage and it may therefore be more reliable to deliver DL control information on FR1. Cross-carrier scheduling may be an effective way to deliver DL control information for FR2 on FR1. As such, CCS with different numerologies between scheduling cell and the scheduled cell may be of practical value. FIG. 2 shows an example of CCS with different numerologies where a scheduling cell with a subcarrier spacing (SCS) of 15 kHz schedules a scheduled cell of SCS=30 kHz. A PDCCH is transmitted on the first three symbols of slot n of the scheduling cell which schedules a PDSCH on slot m+1 of the scheduled cell.

Monitoring of DCI to decode PDCCH is done on the search space (SS) of the scheduling cell. In TS 38.213 V17.2.0 of the 3GPP spec in clause 10.1, the SS and the related UE behavior is described.

The search space (SS) is categorized into common SS (CSS) and UE-specific SS (USS). In the current system, the CSS except for Type3 group common (GC) PDCCH SS is monitored only on the primary cell while USS and Type3 CSS may be monitored in all cells. In case of CCS, no SS is monitored in a scheduled cell. In some embodiments, the primary cell is a scheduled cell, and dynamic spectrum sharing (DSS) may be employed.

From the perspective of a UE, the processing of a DCI to receive a PDSCH or transmit a PUSCH is subject to processing time. In TS 38.214 V17.0.0 of the 3GPP standard, two different UE processing capabilities (capability 1 (cap #1, or Cap 1, or CAP1) and capability 2 (cap #2, or Cap 2, or CAP2)) are defined as specified in clause 5.3 and 6.4. The capability is in terms of the number of orthogonal frequency-division multiplexing (OFDM) symbols (N1 or N2) a UE requires to process a PDSCH or a PUSCH, and those capabilities depend on several parameters including subcarrier spacing (SCS) or numerology μ. It may be seen that N1 or N2 are smaller for cap #2 (shortened processing time) than for cap #1.

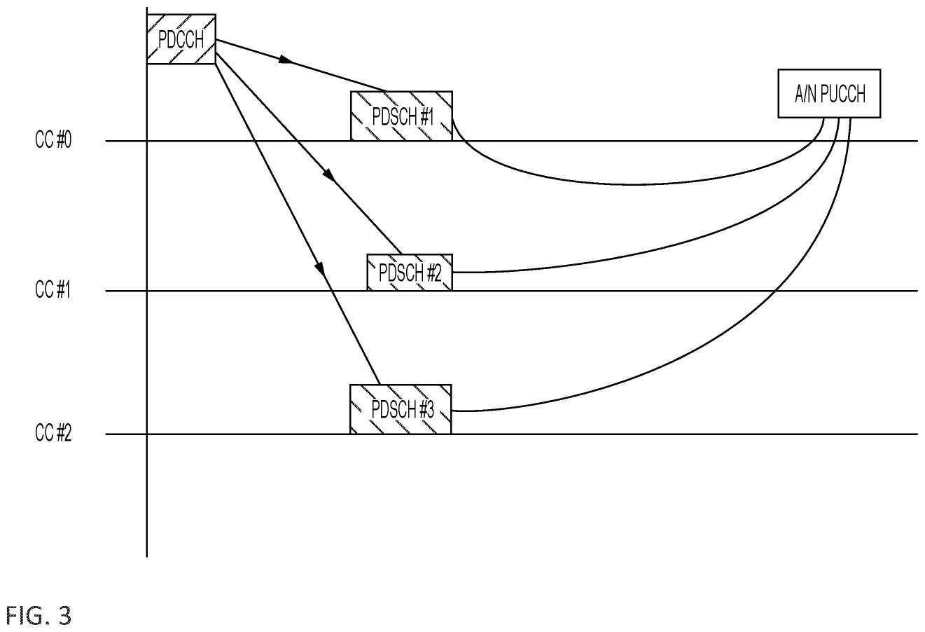

In some embodiments, multiple scheduled cells are scheduled with one DCI on the scheduling cell, as illustrated in FIG. 3. To reduce the control signaling overhead for scheduling downlink or uplink data channels, one DCI may schedule multiple different transport blocks (TB's) in multiple cells in a CA deployment.

When one DCI schedules multiple cells, in one embodiment, parameters in the DCI related to such allocation may be duplicated to have multiple copies. Such allocation parameters may be, but need not be limited to, time domain resource allocation (TDRA), frequency domain resource allocation (FDRA), redundancy version (RV), modulation and coding scheme (MC S), PDCCH-to-PDSCH timing (K0), PDSCH-to-physical UL control signal (PUCCH) timing (K1), PDCCH-to-PUSCH timing (K2), or data assignment index (DAI). Such duplication may increase DCI size and degrade efficiency, which is important for DCIs. In another embodiment, Radio Resource Control (RRC) provides a list of groups of allocation parameters in all cells, and the DCI may indicate an index in the list. Such allocation parameters may be, but need not be limited to, time domain resource allocation (TDRA), frequency domain resource allocation (FDRA), redundancy version (RV), modulation and coding scheme (MCS), PDCCH-to-PDSCH timing (K0), PDSCH-to-physical UL control signal (PUCCH) timing (K1), or PDCCH-to-PUSCH timing (K2). In another embodiment, certain parameters are shared by two cells.

The use of the PDSCH-to-physical UL control signal (PUCCH) timing K1 and PUCCH resource indicator may be affected by whether multiple cells belong to the same PUCCH group. In this case, it may not be advantageous to employ separate PUCCH's. In one embodiment, a single parameter for K1 and a single parameter for the PUCCH Resource Indicator (PRI) are provided, and the actual PUCCH is determined based on the latest PUCCH among hypothetically constructed PUCCH's corresponding to PDSCH numerology and the allocation parameter of each cell. In another embodiment, a single parameter for K1 and a single parameter for the PUCCH resource indicator is provided, and the actual PUCCH is determined based on the earliest PUCCH satisfying the PDSCH processing time of all cells among hypothetically constructed PUCCH's corresponding to the PDSCH numerology and the allocation parameter of each cell. In another embodiment, a certain PDSCH cell is used as a reference cell to determine the actual PUCCH.

If one PUCCH is used, one or more DAI fields may be included in the DCI. If one DAI field is provided, the procedure of constructing Type-2 Hybrid Automatic Repeat Request (HARQ) acknowledgement or negative acknowledgment (ACK/NACK or A/N) (HARQ A/N) codebook provided in clause 9.1.3.1 of TS 38.213 V17.2.0 of the 3GPP spec may be modified. For example, the A/N bit location in the codebook may be generated as ‘N’ consecutive positions where the starting position corresponds to the position of the lowest scheduled cell index, where ‘N’ is the number of scheduled cells in the DCI. In this case, DAI related operation in the codebook may be skipped for all other scheduled cell indices, and the DAI increment may be one for this DCI. The detailed UE behavior for Type-2 HARQ-ACK codebook is described in clause 9.1.3.1 of TS 38.213 V17.2.0 of the 3GPP spec.

In another embodiment, multiple separate PUCCH's are used. A single parameter for K1 and a single parameter for the PUCCH resource indicator may be utilized, and multiple PUCCH's may be constructed based on the single parameter. Multiple DAI fields may be used, since a DAI is with respect to one reference PUCCH slot.

In the following it is assumed that a PDCCH on the scheduling cell schedules N PDSCHs on N serving cells. This disclosure includes a section regarding the use of a Type-2 (dynamic) Hybrid Automatic Repeat Request (HARQ) acknowledgement (HARQ-ACK) codebook and a section regarding the use of a Type-2 HARQ-ACK codebook (CB) with sub-codebooks.

Type-2 (dynamic) HARQ-ACK Codebook

In the following, one Physical Uplink Control Channel (PUCCH) slot is assumed, as the DAI field is with respect to one PUCCH slot. In Rel-15/16, the C-DAI is defined as follows:

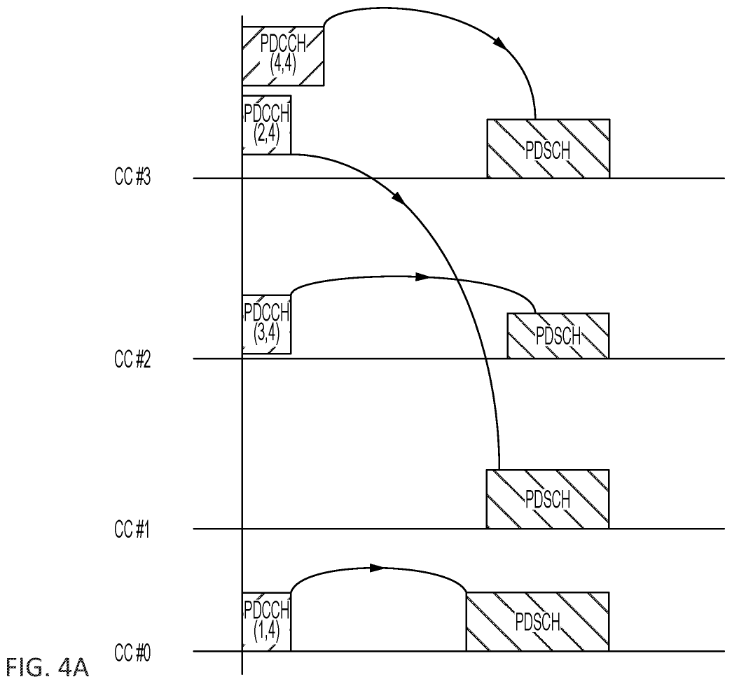

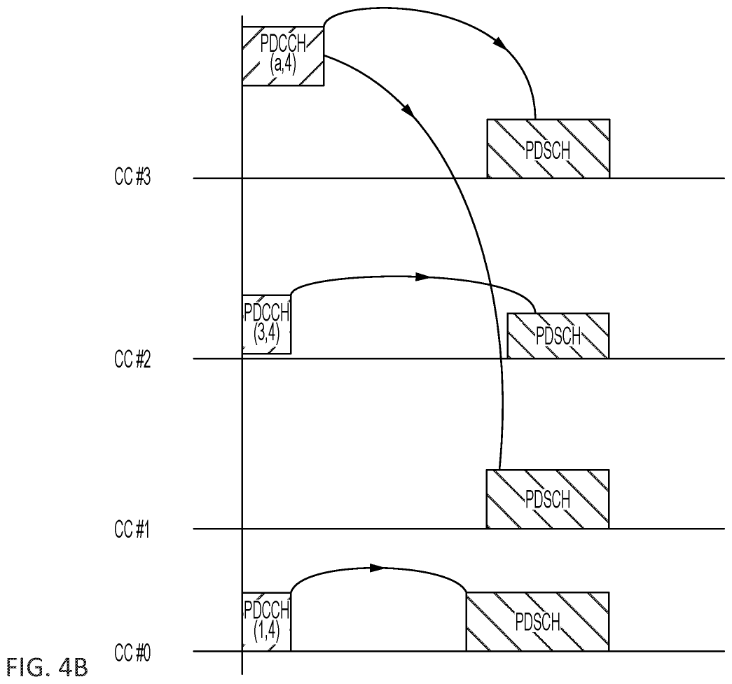

“A value of the counter downlink assignment indicator (DAI) field in DCI formats denotes the accumulative number of {serving cell, PDCCH monitoring occasion}-pair(s) in which PDSCH reception(s) or SPS PDSCH release associated with the DCI formats is present up to the current serving cell and current PDCCH monitoring occasion, first in ascending order of serving cell index and then in ascending order of PDCCH monitoring occasion index m, where 0≤m<M”.

where the “serving cell” is the scheduled cell. FIG. 4A shows a DAI operation in Rel-15 where (C-DAI, T-DAI) pair is shown inside each PDCCH. CC #1 is cross carrier scheduled by CC #3.

Two methods are disclosed, in the context of Type-2 (dynamic) HARQ-ACK codebooks, referred to herein as Method 1 and Method 2.

In Method 1 (N DAI fields), the DAI definition and Type-2 CB is the same as in Rel-15. The UE may consider the detected DCI as N detected DCIS each with the corresponding DAI fields.

If only one DAI field is present in the scheduling DCI, the DAI field may be redefined. FIG. 4B, for example, is a modified version of FIG. 4A in which there is a single DCI replacing the two DCIS scheduling CC #1 and CC #3. The question is what value should be used in place of the C-DAI in the PDCCH on CC #3. If the C-DAI is to provide an accumulative number of {serving cell, PDCCH monitoring occasion}-pair(s) up to CC #1, the value should be 2. If the C-DAI is to provide the accumulative number up to CC #3 the value should be 4. It can be verified that both options work properly in terms of Hybrid Automatic Repeat Request (HARD) and acknowledgment (HARQ-ACK) payload size determination.

In Method 2 (1 DAI field), for a PDCCH scheduling N different cells, a single field for (C-DAI, T-DAI) is present in the DCI. The value of the C-DAI on a PDCCH scheduling serving cells with indices i₁, i₂, . . . , i_{N} denotes the accumulative number of {serving cell, PDCCH monitoring occasion}-pairs in which PDSCH reception or SPS PDSCH release associated with a DCI format up to the current serving cell and current PDCCH monitoring occasion, first in ascending order of serving cell index and then in ascending order of PDCCH monitoring occasion index m, where 0≤m<M, where the current serving cell is the serving cell with largest or smallest index among i₁, . . . , i_{N}. That is, the C-DAI is associated with the cell index c′=max(i₁, . . . , i_{N}) or c′=min(i₁, . . . , i_{N}). The value of the T-DAI has the same meaning as in Rel-15/16. Type-2 CB operation is unaltered except that (i) in the “while c<N_{cells}^{DL}” loop all the cell indices in the set {i₁, . . . , i_{N}}\c′ are skipped, (ii) all the negative acknowledgment (NACK) values used for the skipped indices are not included, and (iii) for the valid ACK/NACK (A/N) bits for the skipped indices, positions in the codebook may be the original positions of NACK values or the new positions consecutively following A/N value of largest or smallest index.

For example, in FIG. 4B, if c′=max(1,3)=3 is considered, a=4 and cell index c=1 in the while loop is skipped. By merely skipping cell index c=1, a NACK value will be generated for the PDSCH on CC #1. With the modification, the NACK bit is replaced by valid A/N bit for the PDSCH on CC #1. If c′=min (1,3)=1, a=2 and cell index c=3 is skipped. By merely skipping cell index c=1, a NACK value will be generated for the PDSCH on CC #3. With the modification, the NACK bit is replaced by valid A/N bit for the PDSCH on CC #3.

The ordering of the A/N bits in the Type-2 CB also needs to be determined. In one method the ordering is based on the start time of the scheduled PDSCHs. That is, the A/N bits are included in ascending order of the starting time of the PDSCHs. If the start times of two PDSCHs are the same, the one with smallest or largest cell index may be put before the other one. Alternatively, the A/N bits may simply be ordered in ascending or descending order of the corresponding cell indices.

Rel-15 specifies the following behavior for Type-2 HARQ-ACK CB. In Rel-15, for a given PDSCH reception either 1 or N_{HARQ-ACK,max}^{CBG/TB,max} bits are generated by user equipment (UE) for a detected dynamic grant (DG) PDSCH or a missed PDCCH scheduling a DG PDSCH, where

$${N}_{HARQ - ACK , max}^{CBG / TB , max} = {max}_{c} {N}_{TB , c}^{DL} \cdot {N}_{HARQ - ACK , c}^{CBG / TB , max} .$$

In the above, N_{TB,c}^{DL} denotes the maximum number of codewords for a serving cell c, which is indicated by Radio Resource Control (RRC) Information Element (IE) maxNrofCodeWordsScheduledByDCI, and N_{HARQ-ACK,c}^{CBG/TB,max} indicates the number of HARQ-ACK bits per codeword or transport block (TB) for serving cell c which is given by RRC IE maxCodeBlockGroupsPerTransportBlock. The reason behind generating a fixed number N_{HARQ-ACK,max}^{CBG/TB,max of bits for a detected or missed PDCCH is that the UE may not be aware of how many CBGs have been scheduled in the missing DCIS. Using a fixed number of bits helps the UE and the gNB have a common understanding on the A/N payload size, although it comes at the price of redundant payload size.}

In the above it is assumed that C-DAI counting is based on the number of scheduled PDSCHs. That is, C-DAI counts the number of PDSCHs. Alternatively, it may count the number of PDCCHs. The issue with counting the PDSCHs is that if a DCI schedules 4 PDSCHs on 4 cells and is missed, the HARQ-ACK payload will be in error as the DAI bit width is only 2 bits. If the DAI is configured to count the number of PDCCHs, it is increased by 1 regardless of the number of scheduled PDSCHs. The definition of C-DAI still needs a reference cell which may be determined according to any suitable method. In that case a maximum number of scheduled PDSCHs may be commonly set between the UE and the gNB, and if the number of scheduled PDSCHs is smaller than that, the UE appends zeros to the A/N bits of the actually scheduled PDSCHs. In general the UE may be RRC configured to operate with either PDCCH-based counting or PDSCH-based counting for DAI fields in the DCI. For PDSCH-based counting, no special handling is needed for Type-2 HARQ-ACK CB.

For PDCCH-based counting, for any transmitted PDCCH, the UE reserves M×N_{HARQ-ACK,max}^{CBG/TB,max} A/N bits, where M is the maximum number of PDSCHs that can be scheduled by a DCI across multiple cells; M may be RRC configured to the UE. If the DCI is missing, all the bits are NACK. If the DCI schedules K≤M PDSCHs, the UE includes the A/N bits of the K PDSCHs in ascending/descending order of the serving cell indices. The ordering of the A/N bits may also be based on the start time of the scheduled PDSCHs. That is, the A/N bits are included in ascending order of the starting time of the PDSCHs. If the start times of two PDSCHs are the same, the one with smallest or largest cell index may be put before the other one. For a PDSCH scheduled on a serving cell c, the UE includes extra zero bits according to Rel-15 behavior in addition to those for the CBGs of the scheduled PDSCH. After placing K×N_{HARQ-ACK,max}^{CBG/TB,max} bits for the scheduled PDSCHs, the UE includes (M−K)×N_{HARQ-ACK,max}^{CBG/TB,max} NACK bits (zero bits).

Type-2 HARQ-ACK CB with Sub-Codebooks

In release 15 (Rel-15) of the 5G new radio (NR) standard, a dynamic (Type-2) hybrid automatic repeat request (HARD) codebook (CB) is constructed based on the counter downlink assignment index (C-DAI) and the total downlink assignment index (T-DAI) indicated to the UE either in the scheduling DCI or a SPS release DCI.

In Rel-15, for a given PDSCH reception either 1 or N_{HARQ-ACK,max}^{CBG/TB,max} bits are generated by the User Equipment (UE) for a detected dynamic grant (DG) PDSCH or a missed PDCCH scheduling a DG PDSCH, where

$${N}_{HARQ - ACK , max}^{CBG / TB , max} = {max}_{c} {N}_{TB , c}^{DL} \cdot {N}_{HARQ - ACK , c}^{CBG / TB , max} .$$

In the above, N_{TB,c}^{DL} denotes the maximum number of codewords for a serving cell c, which is indicated by radio resource control (RRC) information element (IE) maxNrofCodeWordsScheduledByDCI, and N_{HARQ-ACK,c}^{CBG/TB,max} indicates the number of HARQ-ACK bits per codeword or transport block (TB) for serving cell c which is given by RRC IE maxCodeBlockGroupsPerTransportBlock.

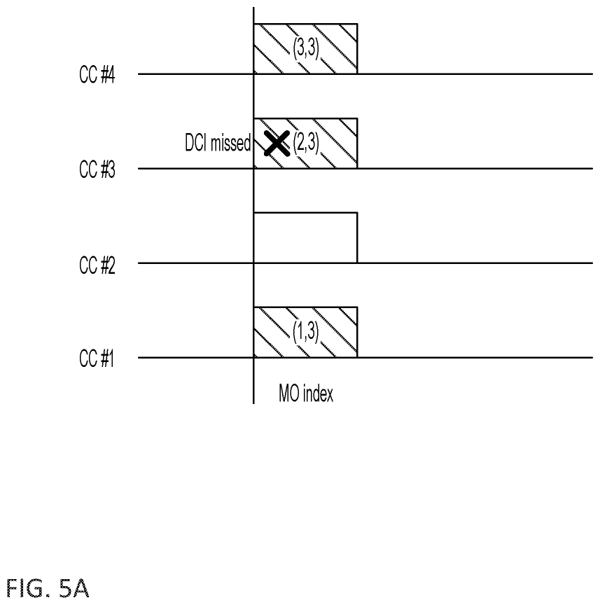

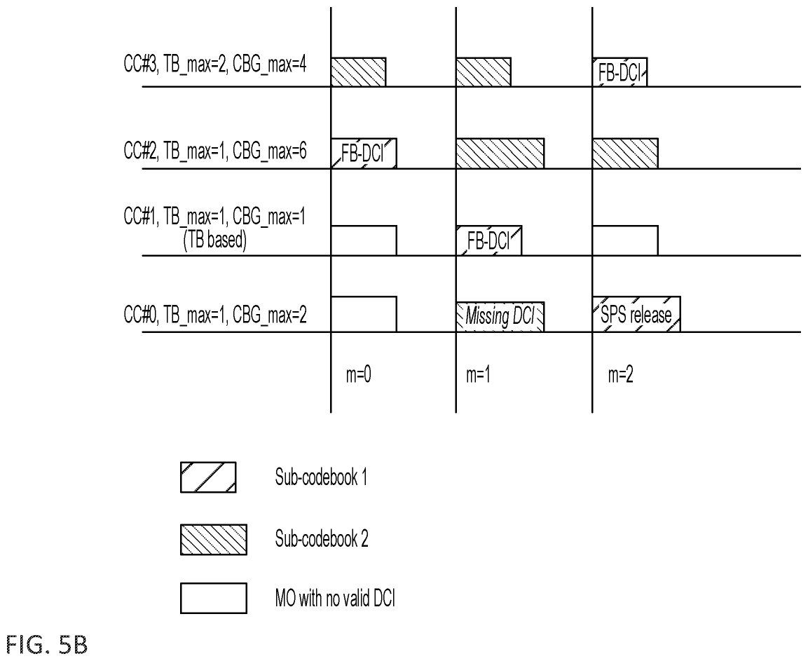

The reason behind generating a fixed number N_{HARQ-ACK,max}^{CBG/TB,max} of bits for a detected or missed PDCCH is that the UE may not be aware of how many CBGs have been scheduled in the missing DCIS. For example, referring to FIG. 5A, the UE may be configured with four serving cells, the maximum number of codewords may be equal to one for every cell, and the maximum number of CBGs that can be received are 2, 3, 4 and 5 for CC #1 to CC #4. If the UE misses the DCI on CC #3, and detects the other two DCIS, it will be aware that it has missed one DCI from the indicated DAI values. However, it cannot determine which cell the missing DCI was transmitted on. If the missing DCI was sent on CC #2, the UE should include 3 NACK bits, while if it was sent on CC #3 it should include 4 NACK bits. To avoid any mismatch between the UE and the gNB on the number of included NACK bits, the UE may simply include a maximum number of possible CBGs across all cells for every detected or missed PDCCH. Considering the number of codewords for each cell, it generates N_{HARQ-ACK,max}^{CBG/TB,max} A/N bits for each scheduling DCI. If the actual number of scheduled CBGs is less than this maximum number, the UE appends zeros.

Although including N_{HARQ-ACK,max}^{CBG/TB,max} bits for every PDSCH can resolve the payload size mismatch issue, it may become inefficient because of zeros appended by the UE. The inefficiency becomes more severe when the maximum number of CBGs configured on different cells varies significantly. As an example, if two cells are only configured with one CBG (or a TB-based transmission), and another two cells are configured with eight CBGs, every A/N bit of the first two cells will have appended to it seven zero bits, which may unnecessarily increase the payload size and have a negative impact on the PUCCH reliability. To mitigate the issue of zero-appending, Rel-15 employs two sub-codebooks as shown below. The first sub-codebook includes all the 1-bit HARQ-ACK bits and the second sub-codebook includes all the N_{HARQ-ACK,max}^{CBG/TB,max}-bit HARQ-ACK bits.

The UE is provided PDSCH-CodeBlockGroupTransmission for N_{cells}^{DL,CBG} serving cells; and is not provided PDSCH-CodeBlockGroupTransmission, for N_{cells}^{DL,TB} serving cells, where N_{cells}^{DL,TB}+N_{cells}^{DL,CBG}=N_{cells}^{DL}.

FIG. 5B shows an example of Type-2 HARQ codebook in Rel-15. There are four monitoring occasions (MOs) which participate in sub-codebook 1 and seven MOs which participate in sub-codebook 2. Four HARQ-ACK bits will be generated by the UE for the four MOs as (a₁, a₂, a₃, a₄) corresponding to (m=MO index, c=serving cell index) (0,2), (1,1), (2,0) and (2,3) respectively. For the rest of the MOs, 8 bits are generated, resulting in the A/N bits of (b₁, b₂, b₃, b₄, b₅) where each bᵢ is 8 bits. All 4 cells participate in the first sub codebook while only CC #0, CC #2 and CC #3 participate in the second sub-codebook.

As mentioned above, if the maximum number of CBGs configured per serving cell varies significantly among the serving cells, having a fixed HARQ-ACK bitwidth per serving cell will generate unnecessarily large overhead for the payload size, as the UE will need to append zero bits. As an example, if all of the serving cells but one are configured with a maximum N_{HARQ-ACK,c}^{CBG/TB,max}=1 CBGs and the one is configured with N_{HARQ-ACK,c}^{CBG/TB,max}=8, the UE will generate 8 bits for all the MOs and serving cells which is significantly redundant as there is only one CBG for all the serving cells but the one. To address this issue, two sub-codebooks are employed in Rel-15 where 1 or N_{HARQ-ACK,max}^{CBG/TB,max} bits are generated for the first and second sub-codebook, respectively. The sub-codes are determined by UE according to the following table:

| | Participation |
|---|---|
| Condition | in sub-code |
| With N_{cells}^{DL} cells: | Sub-codebook 1 |
| PDSCH-CodeBlockGroupTransmission is not provided | |
| for a cell, or | |
| SPS PDSCH with DCI on any cell | |
| SPS PDSCH release on any cell | |
| TB based PDSCH reception when PDSCH- | |
| CodeBlockGroupTransmission is provided for a cell | |
| via fallback DCI (FB-DCI) format 1_0 | |
| With N_{cells}^{DL, CBG} cells: | Sub-codebook 2 |
| If none of the conditions in the cell above are satisfied | |

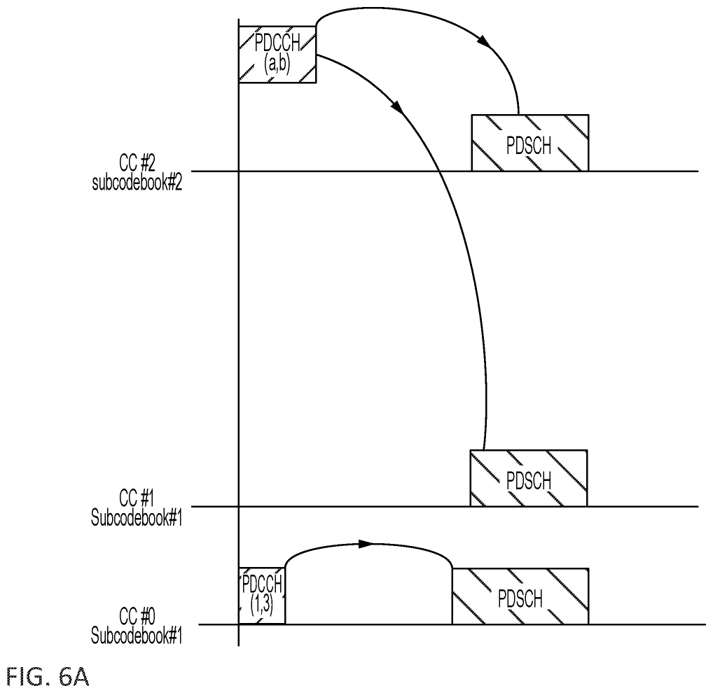

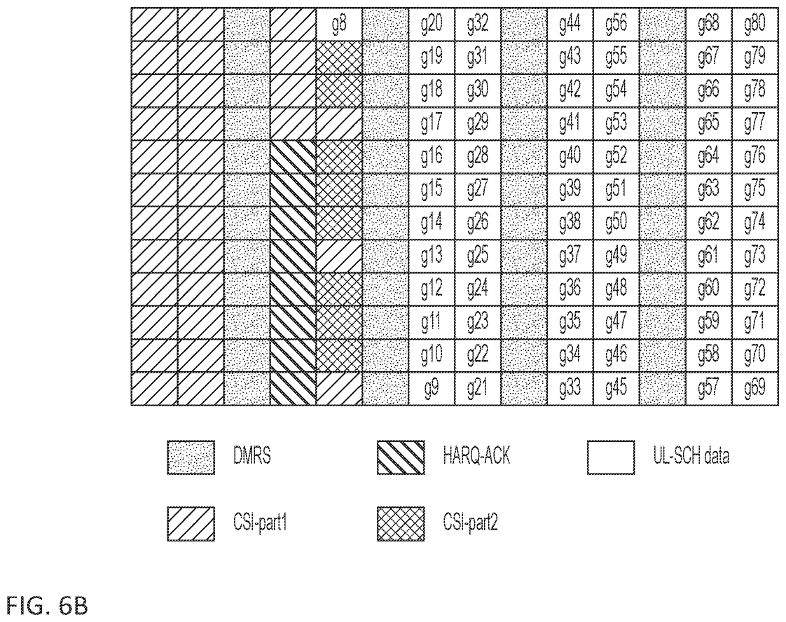

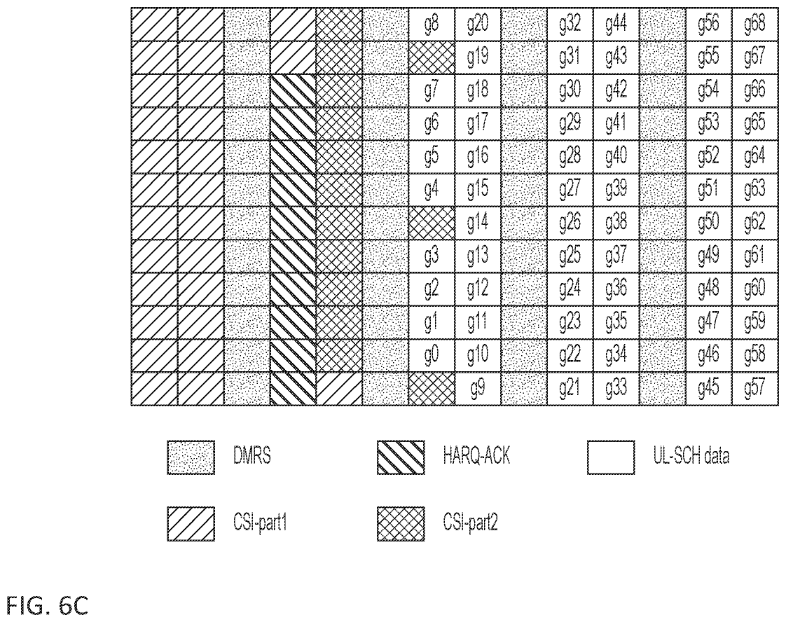

In some embodiments, the scheduling of two PDSCHs in cell #1 and cell #2, when the two cells would fall into two different subcodebooks according to Rel-15/16/17 behavior, as shown in FIG. 6A, is allowed; in other embodiments such scheduling is not allowed. At least when the DAI counts the number of PDSCHs, allowing for such scheduling may defeat the purpose of using independent codebooks to provide robustness towards missing DCIs.

Two methods are disclosed, in the context of Type-2 HARQ-ACK CB with sub-codebooks, referred to herein as Method 1 and Method 2.

In Method 1 (for a case in which the use of different subcodebooks is an error case), when the UE is configured with multiple subcodebooks with Type-2 HARQ-ACK CB, if a DCI on a scheduling cell schedules two PDSCHs on two different scheduled cells, the UE does not expect the two cells to belong to two different HARQ-ACK sub codebooks according to Rel-15 behavior.

Alternatively, a reference serving cell among the scheduled serving cells may be chosen to select the subcodebook.

In Method 2 (for a case in which the use of different subcodebooks is not an error case), when the UE is configured with multiple subcodebooks with Type-2 HARQ-ACK CB, if a DCI on a scheduling cell schedules two PDSCHs on two different scheduled cells CC #1 and CC #2 and the two cells belong to two different subcodebooks according to Rel-15 rules, the UE includes the HARQ-ACK bits of the PDSCHs in the subcodebook of a reference cell among the two cells, e.g., a cell with smallest (or largest) cell index, based on the associated scheduled cell determined from the CIF configuration. The values of (C-DAI, T-DAI) are incremented according to the determined subcodebook.

In FIG. 6A, if CC #1 is selected as the reference cell, the DCI and the two PDSCHs are included in subcodebook #1. The DAI values are (a, b)=(3,3). In FIG. 6A, if CC #2 is selected as the reference cell, the DCI and the two PDSCHs are includes in subcodebook #2. The DAI values are (a, b)=(2,2).

For each scheduling cell, the UE may be configured with the maximum number of cells that may be scheduled by MC DCI. It is also possible that the maximum number of cells is configured to be the same for all scheduling cells. This maximum number may be referred to as Nₘₐₓ. When the MC-DCI schedules N cells, the C-DAI is incremented by 1, but the UE reserves Nₘₐₓ A/N bits. The first N bits correspond to the scheduled cells, while the last Nₘₐₓ−N bits are 0 (NACK) bits. The ordering of the A/N bits may be based on cell index (ascending or descending) or the start or end time of the PDSCHs. For the latter, if two PDSCHs have the same start time, an ordering may be defined based on the cell index. For instance, if two PDSCHs have the same start time, the one with the smallest cell index may be ordered to be before the one with largest cell index.

HARQ-ACK multiplexing in PUSCH may be handled as follows. In legacy NR, a UCI that a UE would transmit in a PUCCH is multiplexed in a PUSCH if the PUCCH and PUSCH overlap. The number of REs for HARQ-ACK and CSI may be determined based on the number of REs of the PUSCH and some control parameters configured to the UE via RRC and indicated via DCI referred to and a offsets, and the HARQ-ACK and CSI payload size as follows.

$${Q}_{ACK}^{′} = min \{ ⌈ \frac{( {O}_{ACJ} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , all}^{PUSCH} - 1} {M}_{sc}^{UCI} ( l ) ⌉ \}$$

$${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , all}^{PUSCH} - 1} {M}_{sc}^{UCI} ( l ) ⌉ - {Q}_{ACK}^{′} \}$$

$${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$$

The coded bits of the HARQ-ACK, CSI part 1 and CSI part 2 may then be placed on the REs of the PUSCH in places. Since fewer REs are available for PUSCH data transmission after UCI multiplexing, only a subset of the data symbols may be chosen to be carried on the available REs of the PUSCH.

There are two different approaches for multiplexing of UCI data on PUSCH: puncturing and rate matching. The following briefly describes the UCI multiplexing procedure.
Uplink Shared Channel (UL-SCH) code bits: g₀^{UL-SCH}, g₁^{UL-SCH}, . . . , g_{G}_{^{UL-SCH}}₋₁^{UL-SCH}
HARQ-ACK code bits: g₀^{ACK}, g₁^{ACK}, . . . , g_{G}_{^{ACK}}₋₁^{ACK}
CSI-part1 code bits: g₀^{CSI-part1}, g₁^{CSI-part1}, . . . , g_{G}_{^{CSI-part1}}₋^{CSI-part1}
CSI-part2 code bits: g₀^{CSI-part2}, g₁^{CSI-part2}, . . . , g_{G}_{^{CSI-part1}}₋₁^{CSI-part2}
No UCI is mapped to any DMRS-carrying symbol

ACK bits are mapped only to REs coming after the set of consecutive DMRS symbols

For number of ACK info bits ≤2 in Step 1, number of REs are reserved for ACK

For number of ACK info bits >2 in Step 2, number of REs are mapped for ACK

| ACK Length ≤ 2 | ACK Length > 2 |
|---|---|
| Step 1: Find the REs and reserve them | Step 1: Do nothing |
| Step 2: Do nothing | Step 2: Map ACK bits to the REs |
| Step 3: | Step 3: |
| Map CSI-part1 to the remaining REs | Map CSI-part1 to the remaining REs |
| (number of available REs must > number of | Map CSI-part2 to the remaining REs |
| reserved REs for ACK) | |
| Map CSI-part2 to the remaining REs | Step 4: Map UL-SCH data bits to remaining |
| Step 4: Map UL-SCH data bits to remaining | REs as many as possible starting from the |
| REs as many as possible starting from the | first bit |
| first bit | Step 5: Do nothing |
| Step 5: Map ACK bits on the reserved REs | |
| (previously filled by UL-SCH data bits starting | |
| from the first bit) | |

If the number of A/N bits is smaller than or equal to 2, puncturing is used. FIG. 6B shows an example of UCI Multplexing on PUSCH with puncturing. If the number of A/N bits is greater than 2, rate matching is used. FIG. 6C shows an example of UCI Multplexing on PUSCH wth rate matching.

PUSCH decoding reliability may be affected. With puncturing PUSCH data symbols are punctured on the reserved REs. This method has the advantage that if the HARQ-ACK payload size is in error, the PUSCH decoding can still succeed. This holds with a fixed reserved or a variable number of REs. On the other hand, rate matching with a variable number of REs is prone to HARQ-ACK payload size error. As an example, in FIG. 6C, if the HARQ-ACK payload size is in error, the data symbols will be shifted on the REs and the gNB and the UE will have a different understanding of the data allocation on the REs. As a result, PUSCH decoding is likely to fail. The HARQ-ACK payload error probability is in general smaller for a small number of DCIs participating in the codebook. For instance, if the payload has only one DCI and if the UE misses it, the payload size will be in error as there is no mechanism for UE to determine the correct number of A/N bits. Therefore, it may be advantageous for PUSCH decoding reliability to be ensured for the payload generated by a small number of DCIs. To ensure the PUSCH decoding reliability two methods are possible, (i) rate matching with a fixed reserved number of REs determined based on a maximum number of A/N bits, or (ii) puncturing with or without a fixed number of REs determined based on a maximum number of A/N bits.

Legacy NR adopted a combination of the two methods. That is, if the number of A/N bits is smaller than or equal to a maximum number of T_{threshold}=2 bits, the UE reserves the number of REs assuming a payload size of 2. It additionally applies puncturing for UCI multiplexing. The value of T_{threshold}=2 in the legacy NR was selected to handle the case of missing one DCI scheduling 1 or 2 transport blocks (TBs). Although the value can handle the missing DCI issue properly in legacy NR where a DCI can only schedule one TB (PDSCH), it may not be efficient when an MC DCI scheduling framework is applied. This may be seen from a situation in which a CM DCI schedules 4 cells. Since the number of A/N bits is greater than 2, the legacy NR specification applies rate matching. However, rate matching in this case may not ensure PUSCH decoding reliability as the A/N payload size error probability may be high due to the presence of only 1 DCI in the payload which may easily be missed by the UE. Therefore, the threshold with MC DCI may be determined by the actual number of DCIs, not by the number of A/N bits. The following method may be employed. With MC scheduling DCI and Type-2 HARQ-ACK CB, if the UE multiplexes the A/N bits in a PUSCH, the threshold T_{threshold} for puncturing and rate matching is determined by any of the following methods.
T_{threshold}=2×the maximum number of cells that can be scheduled by MC DCI
T_{threshold} is RRC configured to the UE

If the UE is configured with multiple scheduling cells for MC scheduling, the threshold determination may take into account the maximum of co-scheduled cells over all the scheduling cells. For example, if CC #0 is configured to schedule M₀ cells via MC DCI format, and CC #1 is configured to schedule M₁ cells via MC DCI format, the maximum number of bits that 1 MC DCI can result in is max(M₀, M₁), so the threshold can be chosen as max(M₀, M₁) if the target is one missing DCI. If the target is up to 2 missing DCIs, the maximum number of A/N bits is max(2M₀, 2M₁, M₀+M₁))=2 max(M₀, M₁). In one embodiment, therefore, the threshold can be set as

$${T}_{threshold} = n \times {max}_{c} {M}_{c} or {T}_{threshold} = n \times {max}_{c} {M}_{c} + 1$$

where M_{c} is the maximum number of co-scheduled cells that can be scheduled with the one MC DCI format on scheduling cell c.

Such adjustments of the value of the threshold are only needed if at least one of the cells is configured for MC DCI format monitoring and the corresponding A/N bits are multiplexed into the HARQ-ACK CB. In other words, if none of the cells whose A/N bits are multiplexed in the HARQ-ACK CB are configured with MC DCI format scheduling, then the legacy threshold may be used.

Once a threshold T_{threshold} is set to make a selection between puncturing and rate matching, the number of A/N bits that the UE uses to determine the number of A/N REs for puncturing can be modified to be based on the actual number of bits rather than the fixed value of T_{threshold}. Using the actual number of A/N bits may have advantages and disadvantages compared to using the fixed threshold value. The actual number of A/N bits the UE possesses may be denoted A (e.g., the UE may possess A A/N bits), with A<T_{threshold}. The following observations may hold regardless of the correctness of the A/N payload size.

| Scheme 1: use threshold number | Scheme 2: use actual number |
|---|---|
| Number of PUSCH data REs is | Number of PUSCH data RE is |
| unnecessarily small | larger −> more reliable PUSCH |
| Number of A/N REs is larger | transmission |
| | Number of A/N REs is smaller |

One advantage of Scheme 2 over Scheme 1 is that in case of an incorrect A/N payload size, the gNB can perform blind decoding of the PUSCH by assuming different values of actual payload size assumed by the UE, hence improving the decoding performance of the PUSCH. In case of incorrect HARQ-ACK payload size, neither of the schemes can recover the A/N information even if the gNB performs blind decoding of HARQ-ACK.

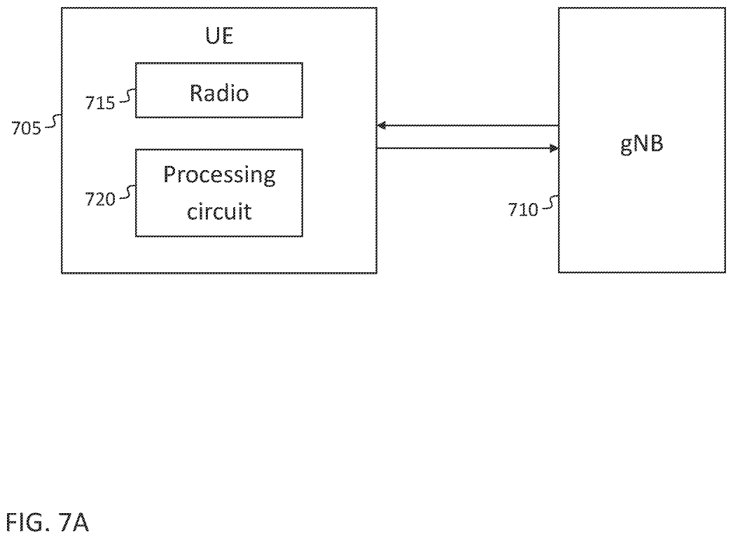

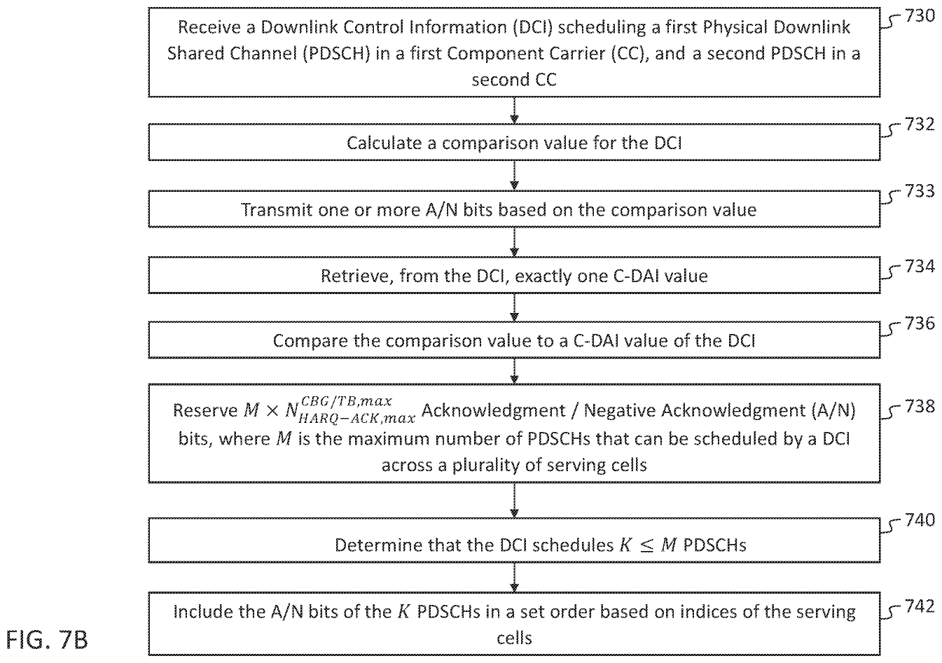

FIG. 7A shows a portion of a wireless system. A user equipment (UE) 705 sends transmissions to a network node (gNB) 710 and receives transmissions from the gNB 710. The UE includes a radio 715 and a processing circuit (or “processor”) 720. In operation, the processing circuit may perform various methods described herein, e.g., it may receive (via the radio, as part of transmissions received from the gNB 710) information from the gNB 710, and it may send (via the radio, as part of transmissions transmitted to the gNB 710) information to the gNB 710.

FIG. 7B is a flow chart of a method, in some embodiments. The UE may, upon receiving a DCI, determine whether it has missed any DCIs, by calculating the value (referred to herein as a “comparison value”) it would expect the C-DAI of the DCI to have, if no DCIs were missed. It may also retrieve, from the DCI, a C-DAI value, and compare the retrieved C-DAI value to the comparison value (with a discrepancy between the retrieved C-DAI value and the comparison value indicating that a DCI was missed). As such, the method may include receiving, at 730, by a User Equipment (UE), a Downlink Control Information (DCI) scheduling: a first Physical Downlink Shared Channel (PDSCH) in a first Component Carrier (CC), and a second PDSCH in a second CC. The method further includes calculating, at 732, by the UE, a comparison value for the DCI, and transmitting, at 733, one or more Acknowledgement/Negative Acknowledgment (A/N) bits based on the comparison value. The calculating may include performing a count over scheduled PDSCHs of CCs with carrier indexes up to and including a carrier index of a reference CC. The method further includes retrieving, at 734, from the DCI, exactly one C-DAI value, and comparing, at 736, the comparison value to a C-DAI value of the DCI.

The method may further include reserving, at 738, by the UE, M×N_(HARQ-ACK,max)\hat{ }(CBG/TB,max) Acknowledgment/Negative Acknowledgment (A/N) bits, where M is the maximum number of PDSCHs that can be scheduled by a DCI across a plurality of serving cells; determining, at 740, that the DCI schedules K≤M PDSCHs; and including, at 742, the A/N bits of the K PDSCHs in a set order based on indices of the serving cells.

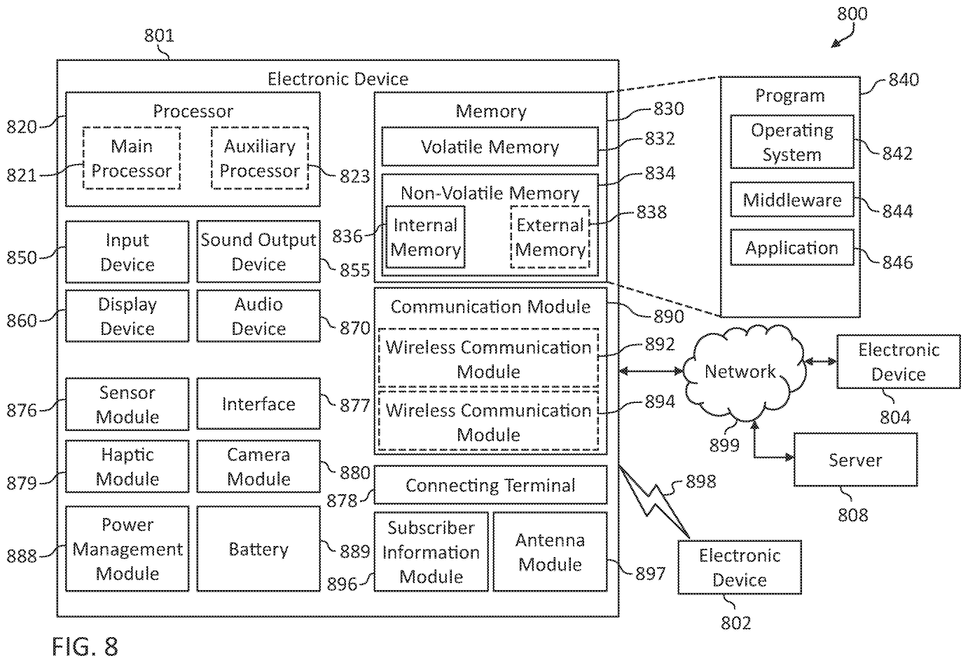

FIG. 8 is a block diagram of an electronic device (e.g., a UE 705) in a network environment 800, according to an embodiment. Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 840, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 894. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 846 or the communication module 890) in volatile memory 832, process the command or the data stored in the volatile memory 832, and store resulting data in non-volatile memory 834. The processor 820 may include a main processor 821 (e.g., a central processing unit (CPU) or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as Bluetooth™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
receiving, by a User Equipment (UE), a Downlink Control Information (DCI) scheduling:
a first Physical Downlink Shared Channel (PDSCH) in a first Component Carrier (CC), and
a second PDSCH in a second CC;
calculating, by the UE, a comparison value for the DCI; and
transmitting one or more Acknowledgement/Negative Acknowledgment (A/N) bits based on the comparison value,
the calculating comprising performing a count over received PDSCHs of CCs with carrier indexes up to and including a carrier index of a reference CC.

2. The method of claim 1, further comprising comparing the comparison value to a C-DAI value of the DCI.

3. The method of claim 2, further comprising retrieving, from the DCI, exactly one C-DAI value.

4. The method of claim 1, wherein the reference CC is the CC, of the first CC and the second CC, having the greater carrier index.

5. The method of claim 1, wherein the reference CC is the CC, of the first CC and the second CC, having the smaller carrier index.

6. The method of claim 1, wherein the performing of the count comprises counting PDSCHs.

7. The method of claim 1, wherein the performing of the count comprises counting PDCCHs.

8. The method of claim 1, further comprising:
reserving, by the UE, M×N_{HARQ-ACK,max}^{CBG,TB,max} Acknowledgment/Negative Acknowledgment (A/N) bits, where M is the maximum number of PDSCHs that can be scheduled by a DCI across a plurality of serving cells;
determining that the DCI schedules K≤M PDSCHs; and
including the A/N bits of the K PDSCHs in a set order based on indices of the serving cells.

9. The method of claim 8, wherein the reserving of the A/N bits comprises reserving only M A/N bits.

10. The method of claim 8, wherein the set order is ascending order of the indices.

11. The method of claim 8, wherein the set order is descending order of the indices.

12. The method of claim 8, wherein M is Radio Resource Control (RRC) configured to the UE by a network node (gNB).

13. A User Equipment (UE) comprising:
one or more processors; and
a memory storing instructions which, when executed by the one or more processors, cause performance of:
receiving a Downlink Control Information (DCI) scheduling:
a first Physical Downlink Shared Channel (PDSCH) in a first Component Carrier (CC), and
a second PDSCH in a second CC; and
calculating a comparison value for the DCI,
the calculating comprising performing a count over received PDSCHs of CCs with carrier indexes up to and including a carrier index of a reference CC.

14. The UE of claim 13, wherein the instructions, when executed by the one or more processors, further cause performance of comparing the comparison value to a C-DAI value of the DCI.

15. The UE of claim 14, wherein the instructions, when executed by the one or more processors, further cause performance of retrieving, from the DCI, exactly one C-DAI value.

16. The UE of claim 13, wherein the reference CC is the CC, of the first CC and the second CC, having the greater carrier index.

17. The UE of claim 13, wherein the reference CC is the CC, of the first CC and the second CC, having the smaller carrier index.

18. The UE of claim 13, wherein the performing of the count comprises counting PDSCHs.

19. The UE of claim 13, wherein the performing of the count comprises counting PDCCHs.

20. A User Equipment (UE) comprising:
means for processing; and
a memory storing instructions which, when executed by the means for processing, cause performance of:
receiving a Downlink Control Information (DCI) scheduling:
a first Physical Downlink Shared Channel (PDSCH) in a first Component Carrier (CC), and
a second PDSCH in a second CC; and
calculating a comparison value for the DCI,
the calculating comprising performing a count over received PDSCHs of CCs with carrier indexes up to and including a carrier index of a reference CC.
